(19) United States
(12) Patent Application Publication
(10) Pub. No.: US 2006/0266880 A1
(43) Pub. Date: Nov. 30, 2006

(54) Servo fixing base structure for remote control helicopers

(76) Inventor: Chien-chao Chen, Taipei (TW)

Correspondence Address: Chien-chao Chen, 20525 Via Talavera,, Yorba Linda, CA, 92887, US

(21) Appl. No.: 11/431,854

(22) Filed: May 11, 2006

(30) Foreign Application Priority Data
May 26, 2005 (TW) 094208672

(51) Int. Cl. B64C 27/00

(52) U.S. Cl. 244/17.11

(57) ABSTRACT

A servo fixing base structure for remote control helicopters includes a main base, and a slanting support stand. The main base connects upper and lower base portions by two propping portions and includes two lateral portions for connecting a sideboard of an airframe, a main shaft hole disposed at the centers of the upper and lower base portions for passing a main rotor axle, a lateral support portion extended from a propping portion, a containing space disposed at the lateral support portion for mounting a servo, two connecting surfaces disposed at another propping portion, and a connecting surface for connecting the main base, such that the two slanting support stands evenly extended from the lateral support portion, and the middle section of the slanting support stand includes a containing space for mounting the two servos, such that each servo is securely installed at the main rotor axle.

### FIELD OF THE INVENTION

The present invention relates to an improved servo fixing base structure for remote control helicopters, and more particularly to a servo fixing base capable of connecting a fuselage sideboard to improve the strength of an airframe of a helicopter and the stability of controlling the helicopter.

### BACKGROUND OF THE INVENTION

Referring to FIG. 1 for a traditional remote control helicopter and its servo fixing base structure, an airframe 5 is a hollow tubular body for containing a transmission mechanism 51 connected to a motive power source, and the transmission mechanism 51 drives a vertically extended main rotor axle 511 to rotate, and the airframe 5 includes a servo fixing base 6 disposed at the top of the airframe 4, and the servo fixing base 6 is comprised of an upper support stand 61, a sleeve 62 and a lower support stand 63 passed through the periphery of the main rotor axle 511, such that the support of the sleeve 62 can separate the upper and lower support stands 61, 63 having an appropriate distance apart, and the periphery of both the upper and lower support stands 61, 63 has a plurality of outwardly radiant extended support portions for vertically and respectively mounting a servo 601, 602, 603, and each servo 601, 602, 603 is controlled and driven by a remote controller to move the driving arm 6021 to achieve the effect of controlling different flying actions of the remote control helicopters.

Since there is no secured positioning and fixing relation among the upper support stand 61 of the servo fixing base 6, the sleeve 62, the lower support stand 63, the airframe 5, and the main rotor axle 511 in the aforementioned structure, the strong air current and mechanical action produced during the flying of a remote control helicopter may easily change the connecting positions among the upper support stand 61, the sleeve 62, and the lower support stand 63 (including mutual shifts, distortions or deformations), such that the positions among the servos 601, 602, 603 may change as well, and each driving arm cannot accurately control the remote control helicopter, and thus unstable flying actions may result.

In view of the foregoing shortcomings of the traditional remote control helicopter and its servo fixing base structure, the inventor of the present invention based on years of experience in the related industry to conduct extensive researches and experiments, and invented the present invention to overcome the shortcomings of the prior art.

### SUMMARY OF THE INVENTION

In view of the shortcoming of the prior art, the inventor of the present invention based on years of experience in the related industry to conduct extensive researches and experiments, and finally invented an improved servo fixing base structure for remote control helicopters in accordance with the present invention.

Therefore, it is a primary objective of the present invention to provide an improved servo fixing base structure for remote control helicopters that integrates and secures a main base with two slanting support stands to provide a plurality of outwardly extended radiant support portions, and each support portion includes a containing space for transversally containing and mounting a servo to constitute a secured servo fixing base structure, and a lateral portion disposed at a side of the connecting position between the main base and the two slanting support stands for connecting two preinstalled sideboards of the airframe to provide an excellent connecting strength for the overall structure, and thus external forces will not shift, twist or deform the structure easily, so as to effectively assure the stability of flying and the accuracy of control operations.

The detail structure, applied principles, effects and performance of the present invention will become apparent in the following detailed description taken with the accompanying drawings.

### BRIEF DESCRIPTION OF THE DRAWINGS

FIG. 1 is a schematic view of the structure of a traditional remote control helicopter and its servo fixing base;

FIG. 2 is an exploded view of a structure of the present invention;

FIG. 3 is an exploded view of a structure and its related airframe of the present invention;

FIG. 4 is a partial exploded view of a structure and its related airframe of the present invention; and

FIG. 5 is a schematic view of an assembled structure and its related airframe of the present invention.

### DETAILED DESCRIPTION OF THE PREFERRED EMBODIMENTS

To make it easier for our examiner to understand the objective, features, and performance of the present invention, we use a preferred embodiment together with the attached drawings for the detailed description of the invention.

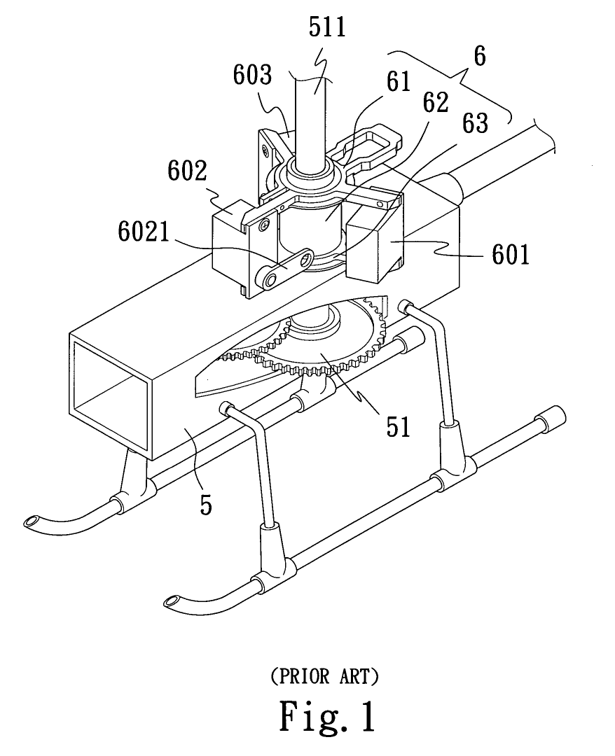

Referring to FIG. 1 for the traditional remote control helicopter and its servo fixing base structure, the main structure and its shortcomings have been described previously, and thus will not be repeated here.

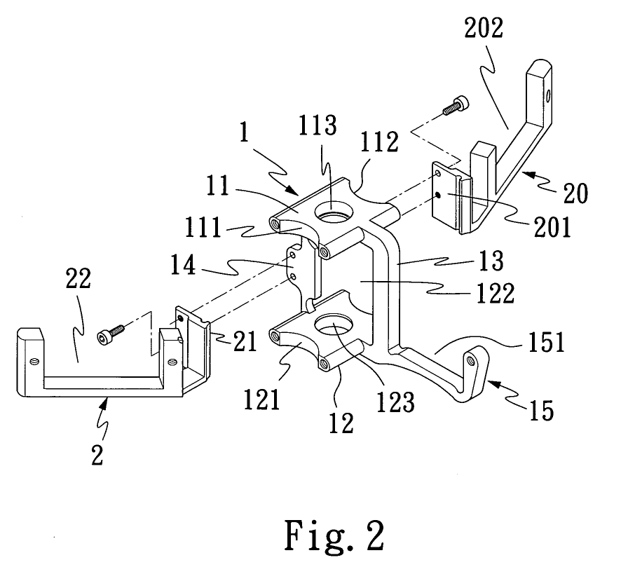

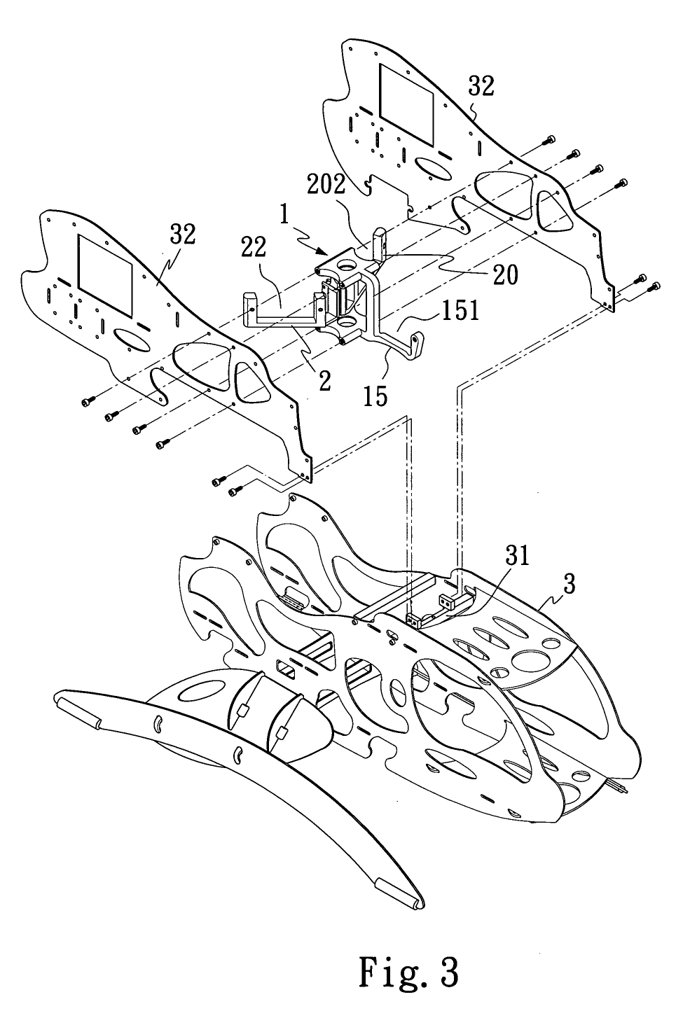

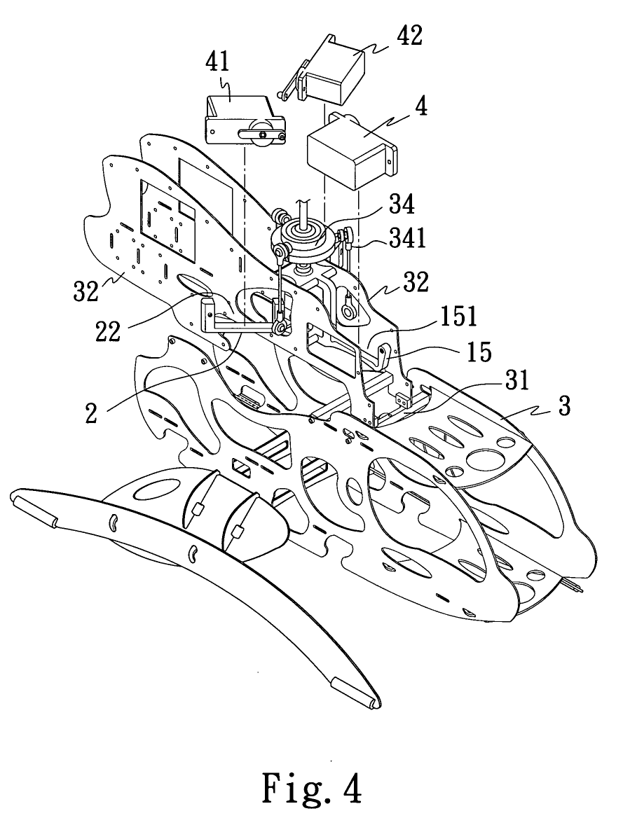

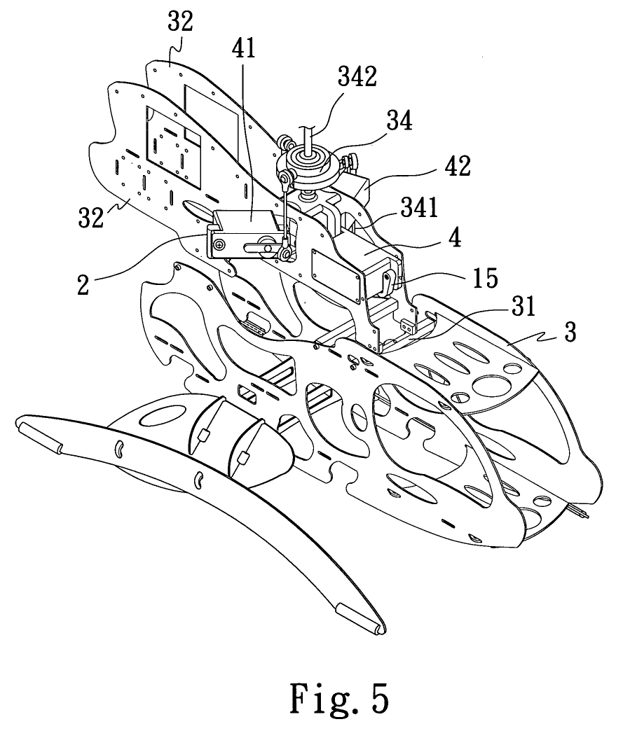

Referring to FIG. 2 for the exploded view of a structure of the present invention and FIGS. 3 to 5 for the schematic views of a related airframe of the invention, the invention comprises a main base 1, a slanting support stand 2 and a slanting support stand 20. The main base 1 connects upper and lower base portions 11, 12 by two propping portions 13, 14, and the upper and lower base portions 11, 12 include a main shaft hole 113, 123 penetrating the upper and lower base portions 11, 12 respectively, two lateral portions 111, 112, 121, 122 disposed separately on the sides of the upper and lower base portions 11, 12, a lateral support portion 15 extended from the external side of the propping portion 13 and having a containing space 151 disposed at the middle section of the lateral support portion and two connecting surfaces disposed at the periphery of another propping portion 14, and an end of each slanting support stand 2, 20 includes a slanting extended connecting surface 21, 201, and a containing space 22, 202 disposed at the middle section of the two slanting support stands 2, 20, such that the two slanting support stands 2, 20 can be connected to two connecting surfaces of the propping portion 13 by the connecting surface 21, 201 during the assembling, and the two slanting support stands 2, 20 are extended outward in a radiant form with respect to the lateral support portion 15 of the main base 1. A fixed support stand 31 is disposed transversally on an airframe 3 for combining two side-by-side sideboards 32, so that the main base 1 can be integrated with the sideboards 32 of the airframe 3 by the lateral portions 111, 121, 112, 122 to constitute a secured positioning. The main shaft holes 113, 123 of the upper and lower base portions 11, 12 receive a bearing, and a main rotor axle 342 passes through the main shaft holes 113, 123, and the servos 4, 41, 42 are contained and fixed into the containing space 151 of the lateral support portion 15 and the containing space 22, 202 of the two slanting support stands 2, 20 respectively, such that each servo 4, 41, 42 can be evenly disposed on the same plane of the periphery of the main rotor axle 342, and the servos 4, 41, 42 can be coupled to a periphery of a main driving disc 34 by a driving arm through a plurality of link rods 341, and the main driving disc 34 can be connected to the periphery at the middle section of the main rotor axle 342, and each servo 4, 41, 42 can be controlled by a remote controller to drive the driving arm to tilt the main driving disc 34, so as to accurately control different flying actions of the remote control helicopter.

In summation of the description above, the improved servo fixing base structure for remote control helicopters of the present invention herein enhances the performance over the conventional structure and complies with the patent application requirements.

What is claimed is:

1. An improved servo fixing base structure for remote control helicopters, comprising:
a main base, for coupling upper and lower base portions with an appropriate distance apart by two propping portions, and including a main shaft hole penetrating through the centers of said upper and lower base portions for passing a main rotor axle, a lateral support portion extended outwardly from a propping portion being disposed between said upper and lower base portions, a containing space disposed at the middle section of said lateral support portion for containing and mounting a servo, and two connecting surfaces disposed at the periphery of another propping portion; two slanting support stands, each having a slanting extended connecting surface at an end of said each slanting support stand for connecting said two connecting surfaces of said main base, such that said two slanting support stands are extended outward in a radiant form with respect to said lateral support portion, and said slanting support stands having a containing space disposed at the middle section of said each slanting support stand for containing and mounting two servos, such that said each servo can be installed evenly at the periphery of said main rotor axle to improve the accuracy of controlling said remote control helicopters.

2. The improved servo fixing base structure for remote control helicopters of claim 1, wherein said upper and lower base portions include two lateral portions disposed on both sides of said upper and lower base portions and coupled to a sideboard of an airframe for effectively improving the overall connecting strength for said remote control helicopters.
